(19) United States
(12) Patent Application Publication
(10) Pub. No.: US 2013/0153775 A1
(43) Pub. Date: Jun. 20, 2013

(54) RADIATION DETECTION APPARATUS

(71) Applicant: CANON KABUSHIKI KAISHA, Tokyo (JP)

(72) Inventors: Keiichi Nomura, Honjo-shi (JP); Satoshi Okada, Tokyo (JP); Kazumi Nagano, Honjo-shi (JP); Shoshiro Saruta, Tokyo (JP); Yohei Ishida, Honjo-shi (JP); Yoshito Sasaki, Honjo-shi (JP); Tomoaki Ichimura, Kitamoto-shi (JP); Akiya Nakayama, Kawasaki-shi (JP)

(73) Assignee: CANON KABUSHIKI KAISHA, Tokyo (JP)

(21) Appl. No.: 13/690,527

(22) Filed: Nov. 30, 2012

(30) Foreign Application Priority Data
Dec. 16, 2011 (JP) 2011-276140

(51) Int. Cl. G01T 1/20

(52) U.S. Cl. CPC G01T 1/2006
USPC 250/366

(57) ABSTRACT

A radiation detection apparatus comprising, a sensor panel including sensor unit disposed on a plurality of photoelectric converters on a substrate, a first scintillator layer disposed on the sensor panel, and a second scintillator layer disposed on the first scintillator layer, wherein the first scintillator layer and the second scintillator layer respectively emit light beams having different wavelengths, and the sensor unit which includes a first photoelectric converter configured to detect the light beam emitted by the first scintillator layer, a first transistor configured to output a signal from the first scintillator layer, a second photoelectric converter configured to detect the light beam emitted by the second scintillator layer, and a second transistor configured to output a signal from the second scintillator layer, and individually convert the light beams having the different wavelengths into electrical signals.

### BACKGROUND OF THE INVENTION

1. Field of the Invention

The present invention relates to a radiation detection apparatus.

2. Description of the Related Art

An energy subtraction scheme is available as one of the imaging schemes using radiation emission. This scheme is designed to acquire a desired image based on the difference information between two radiographic images by using radiations with different energy distributions.

For example, Japanese Patent Laid-Open No. 7-120557 discloses a radiation detection apparatus using the scintillator obtained by mixing two different phosphor materials. This structure allows two pieces of radiographic image information to be acquired by one radiation emitting operation and implement an energy subtraction scheme. It is however not easy to uniformly mix different phosphor materials because of production variation and the like. It is difficult to acquire high-resolution radiographic images.

### SUMMARY OF THE INVENTION

The present invention provides a radiation detection apparatus which is advantageous to the acquisition of high-resolution radiographic images and can be stably manufactured.

One of the aspects of the present invention provides a radiation detection apparatus comprising, a sensor panel including sensor unit disposed on a plurality of photoelectric converters on a substrate, a first scintillator layer disposed on the sensor panel, and a second scintillator layer disposed on the first scintillator layer, wherein the first scintillator layer and the second scintillator layer respectively emit light beams having different wavelengths, and the sensor unit which includes a first photoelectric converter configured to detect the light beam emitted by the first scintillator layer, a first transistor configured to output a signal from the first scintillator layer, a second photoelectric converter configured to detect the light beam emitted by the second scintillator layer, and a second transistor configured to output a signal from the second scintillator layer, and individually convert the light beams having the different wavelengths into electrical signals.

Further features of the present invention will become apparent from the following description of exemplary embodiments with reference to the attached drawings.

### BRIEF DESCRIPTION OF THE DRAWINGS

FIGS. 1A and 1B are views for explaining an example of the arrangement of a radiation detection apparatus according to the first embodiment;

FIG. 2 is a graph for explaining the wavelength distributions of light beams detected by a sensor unit in the first embodiment;

FIG. 3 is a graph for explaining the relationship between the thickness of a scintillator layer and the X-ray transmittance in the first embodiment;

FIG. 4 is a view for explaining the arrangement of the radiation detection apparatus according to the first embodiment;

FIG. 5 is a view for explaining an example of the sectional structure of a sensor unit in the first embodiment;

FIG. 6 is a view for explaining an example of the operation of the sensor unit in the first embodiment;

FIGS. 7A and 7B are views for explaining an example of the sectional structure of a color filter layer according to the second embodiment;

FIGS. 8A to 8H are views for explaining an example of the pattern of the color filter layer in the second embodiment;

FIGS. 9A to 9C are views for explaining the arrangement of a radiation detection apparatus according to the second embodiment;

FIG. 10 is a graph for explaining the wavelength distributions of light beams detected by a sensor unit in the second embodiment; and

FIG. 11 is a view for explaining a radiographic system to which the radiation detection apparatus of the present invention is applied.

### DESCRIPTION OF THE EMBODIMENTS

### First Embodiment

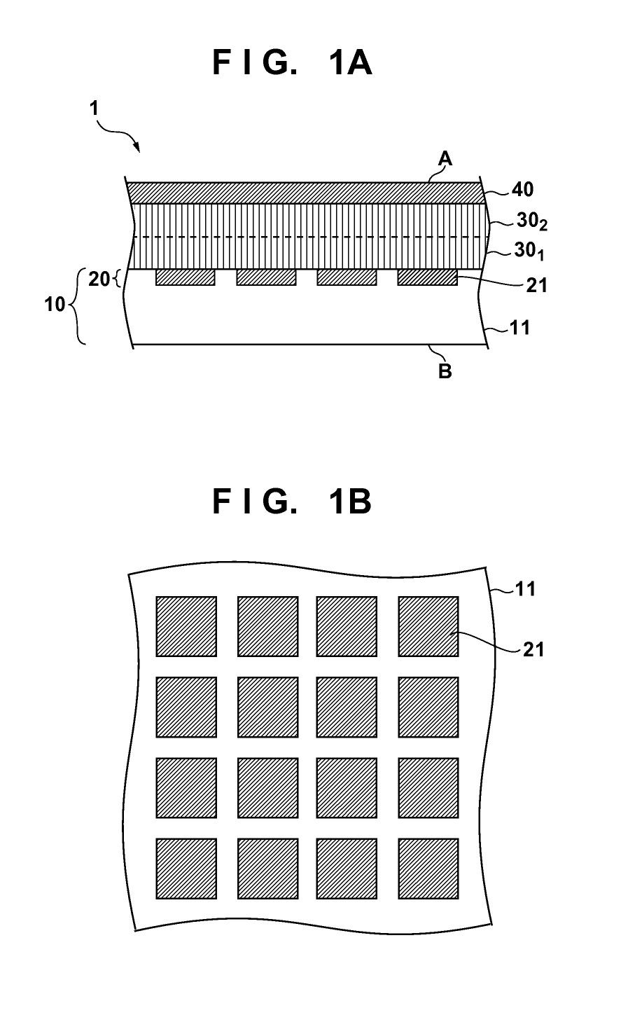

A radiation detection apparatus 1 according to the first embodiment will be described with reference to FIGS. 1A to 6. FIGS. 1A and 1B are views for explaining the radiation detection apparatus 1. FIG. 1A is a schematic view of the sectional structure of the radiation detection apparatus 1. FIG. 1B is a schematic view of the planar layout of the radiation detection apparatus 1.

The radiation detection apparatus 1 can include a sensor panel 10, a first scintillator layer 30₁, and a second scintillator layer 30₂. The sensor panel 10 can include a sensor unit 20 having a plurality of photoelectric converters 21 two-dimensionally arranged on a substrate 11. The first scintillator layer 30₁ is disposed on the sensor panel 10. The second scintillator layer 30₂ is disposed on the first scintillator layer 30₁. The first and second scintillator layers 30₁ and 30₂ convert radiations (including electromagnetic waves such as X-rays, α-rays, β-rays, and γ-rays) into light beams. In general, the first and second scintillator layers 30₁ and 30₂ are often formed from columnar crystal structures to suppress light scattering and improve resolution. The first and second scintillator layers 30₁ and 30₂ can respectively include different materials. The radiation detection apparatus 1 can include a scintillator protective layer 40 on the second scintillator layer 30₂.

Consider a case in which radiations with different energy distributions enter from an upper surface A of the scintillator protective layer 40. The second scintillator layer 30₂ near the upper surface A which radiation enters can mainly convert low-energy radiation into a light beam. On the other hand, the first scintillator layer 30₁ can mainly convert high-energy radiation into a light beam. As described above, the second scintillator layer 30₂ converts part of incident radiation into a light beam. The first scintillator layer 30₁ can convert the radiation transmitted through the second scintillator layer 30₂ into a light beam.

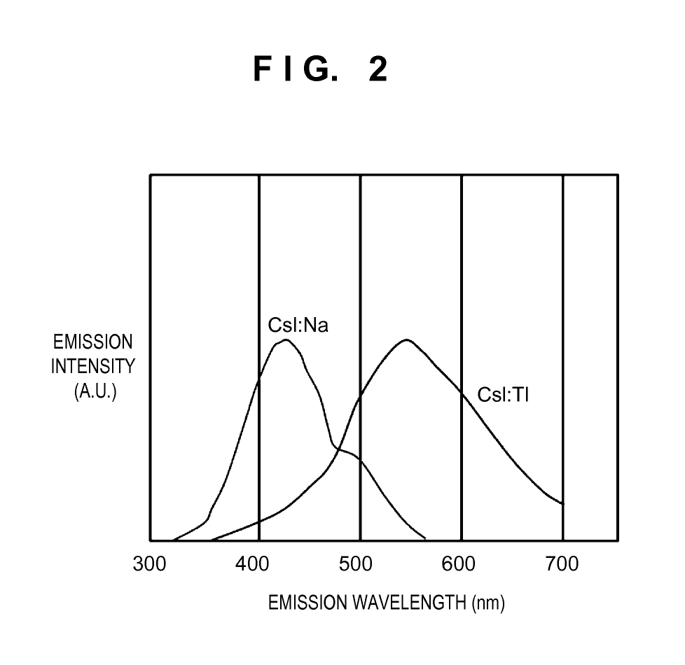

In this case, the first and second scintillator layers 30₁ and 30₂ contain different materials, they can emit light beams having different wavelengths. Of these wavelengths of the light beams, the wavelength of the light beam emitted by the first scintillator layer 30₁ is represented by λ₁ and the wavelength of the light beam emitted by the second scintillator layer 30₂ is represented by λ₂. In this case, it is preferable to set wavelengths so as to hold the relationship of λ₁<λ₂. This makes it possible to reduce the amount of light beam which is emitted by the second scintillator layer 30₂ and absorbed to disappear by the first scintillator layer 30₁. For example, CsI:Na can be used for the first scintillator layer 30₁. For example, CsI:Tl or CsI:In can be used for the second scintillator layer 30₂. FIG. 2 shows the wavelength characteristics of emitted light beams when CsI:Na is used for the first scintillator layer 30₁ and CsI:Tl is used for the second scintillator layer 30₂. When radiation enters the surface on the opposite side (a lower surface B in FIG. 1A), it is preferable to form these layers in the reverse order.

The first and second scintillator layers 30₁ and 30₂ can use, for example, CsI and NaI layers or the like formed by vacuum deposition, printing method, or the like. It is possible to form the first and second scintillator layers 30₁ and 30₂ by doping Na, Tl, and the like in CsI layers while they are formed by vapor deposition. It is preferable to form a CsI layer by vapor deposition under the condition of a substrate temperature of 200° C. or higher.

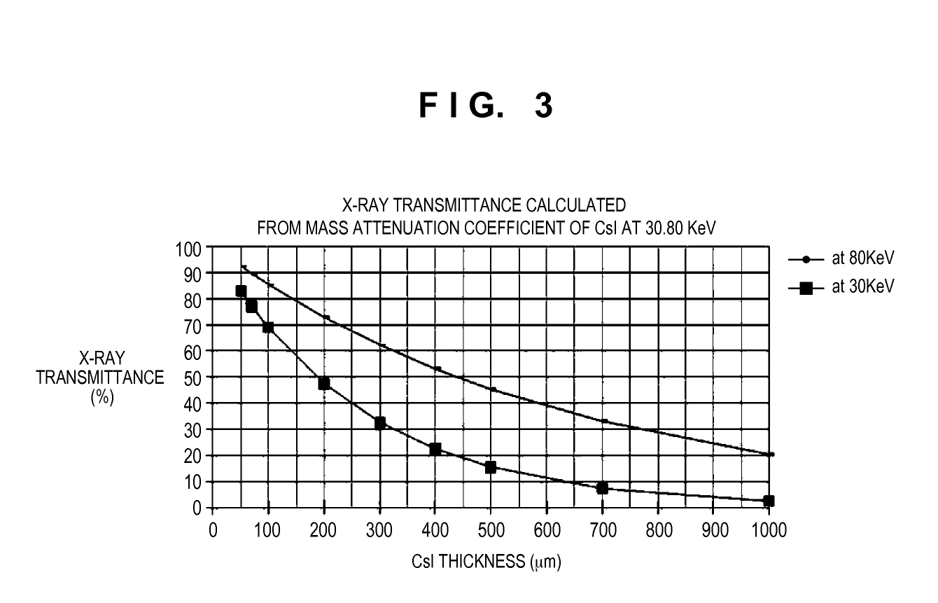

In this case, it is preferable to provide the first and second scintillator layers 30₁ and 30₂ to respectively have thicknesses that clarify the difference between the image information obtained by the emission of low-energy radiation and the image information obtained by the emission of high-energy radiation. For example, it is possible to provide the first and second scintillator layers 30₁ and 30₂ to respectively have thicknesses that make the high-energy radiation transmittance almost twice higher than the low-energy radiation transmittance. FIG. 3 shows the dependences of the X-ray transmittance on the thickness of the scintillator layer (CsI) when a known X-ray emitter emits X-rays with energies of 30 keV and 80 keV. As is obvious from FIG. 3, when the thickness of a scintillator layer is set to 300 to 400 μm, the X-ray transmittance ratio becomes 0.48 to 0.58, thereby obtaining a clear subtraction image.

It is possible to use, for the scintillator protective layer 40, for example, an organic resin material such as polyethylene terephthalate (PET), polyimide (PI), polyparaxylylene (parylene), or polyuria. It is possible to use, for the scintillator protective layer 40, for example, an adhesive organic resin material such as a hot-melt resin or a metal material such as aluminum. Alternatively, a structure obtained by staking layers made of these materials (for example, a structure obtained by stacking PET, aluminum, and hot-melt resin layers) may be used for the scintillator protective layer 40.

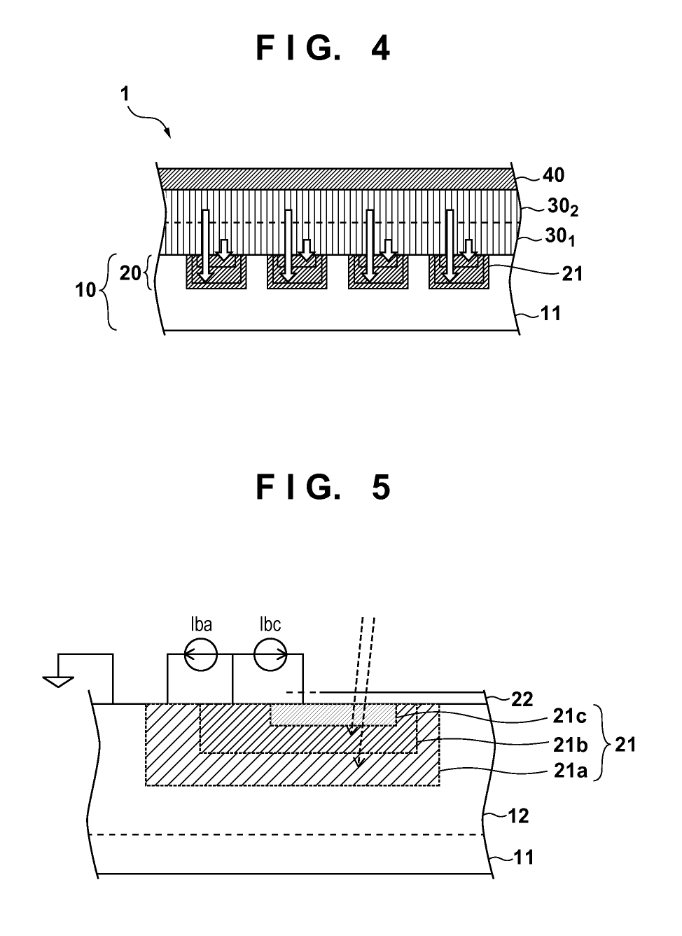

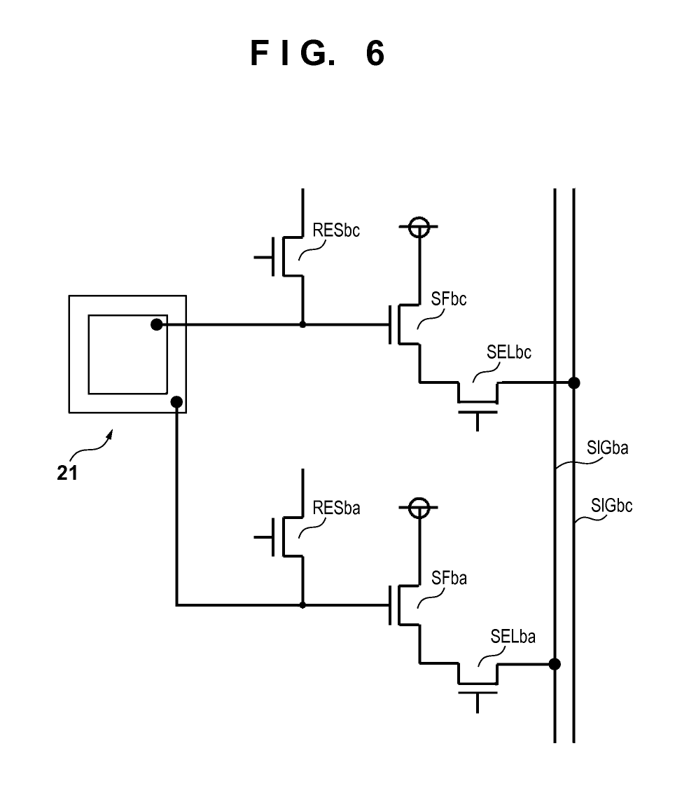

As exemplified by FIG. 4, the photoelectric converters 21 may be any photoelectric converters which can individually detect light beams having different wavelengths generated by the first and second scintillator layers 30₁ and 30₂. For example, it is possible to use the photoelectric converters 21 having an n-p-n triple well structure. The sectional structure of the photoelectric converter 21 will be described with reference to FIG. 5. A p-type semiconductor region 12 disposed on the substrate 11 (p-type semiconductor) can be provided to electrically isolate the photoelectric converter 21 from the substrate 11 and to electrically isolate the respective adjacent photoelectric converters 21. The p-type semiconductor region 12 can be connected to ground. As exemplified by FIG. 5, the photoelectric converter 21 can sequentially include, in the p-type semiconductor region 12, an n-type diffusion layer 21a, a p-type diffusion layer 21b disposed inside the n-type diffusion layer 21a, and an n-type diffusion layer 21c disposed inside the p-type diffusion layer 21b. In this manner, the photoelectric converter 21 includes two photodiodes disposed at different depth positions from the surface of the substrate 11. This allows the photoelectric converter 21 to individually detect the light beam generated by the first scintillator layer 30₁ and the light beam generated by the second scintillator layer 30₂ and output electrical signals corresponding to them. A passivation layer 22 can be provided on the semiconductor region including the diffusion layers 21a, 21b, and 21c described above. The passivation layer 22 is a member having high translucency and can transmit light beam from the first and second scintillator layers 30₁ and 30₂. It is possible to use, for the passivation layer 22, for example, a member containing at least one of SiN, SiON, SiO, SiO₂, siloxane, and an acrylic resin containing no ultraviolet absorbent (or containing little ultraviolet absorbent).

A p-n junction Dba between the n-type diffusion layer 21a and the p-type diffusion layer 21b may be provided at a depth that allows efficient detection of a light beam having the wavelength λ₂ emitted by the second scintillator layer 30₂. A p-n junction Dbc between the p-type diffusion layer 21b and the n-type diffusion layer 21c may be provided at a depth that allows efficient detection of a light beam having the wavelength λ₁ emitted by the first scintillator layer 30₁. Upon reception of a light beam, electron-hole pairs are generated in the p-n junction Dba between the n-type diffusion layer 21a and the p-type diffusion layer 21b, and a current Iba can flow in the junction. Likewise, a current Ibc can flow in the p-n junction Dbc between the p-type diffusion layer 21b and the n-type diffusion layer 21c. Disposing the first photoelectric converter (Dbc) and the second photoelectric converter (Dba) at different depth positions from the surface of the substrate in this manner allows a sensor unit 20 to individually detect light beams having different wavelengths. These two p-n junctions may be provided by implanting ions into the substrate 11 with different implantation concentrations. In addition, these two p-n junctions may be provided according to the procedure of providing the first p-n junction on the upper portion of the semiconductor substrate 11 first and then providing the second p-n junction by epitaxially growing a semiconductor layer.

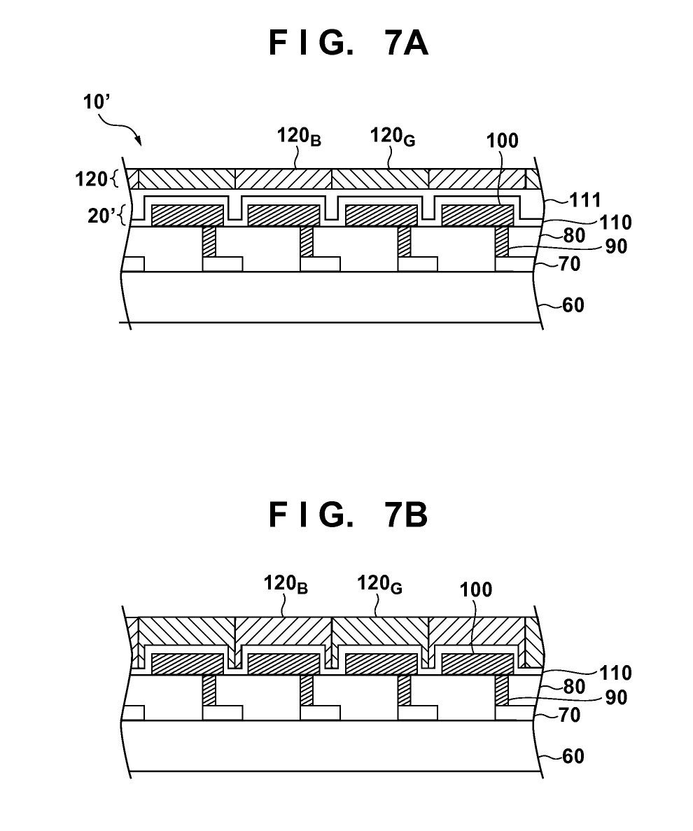

As exemplified by FIG. 6, the current Iba generated in the p-n junction Dba can be read via an amplification transistor SFba and a selection transistor SELba. Likewise, the current Ibc generated in the p-n junction Dbc can be read via an amplification transistor SFbc and a selection transistor SELbc. The read signals can be output as signals SIGba and SIGbc to a column signal line. As exemplified by FIG. 6, these reading circuits can respectively include reset transistors RESba and RESbc for respectively resetting the potentials of the gates of the amplification transistors SFba and SFbc to predetermined values. As described above, the radiation detection apparatus 1 can improve the DQE (Detective Quantum Efficiency) to efficiently detect the light beams emitted by the first and second scintillator layers 30₁ and 30₂.

As described above, the radiation detection apparatus 1 can convert radiations with different energy distributions into light beams having different wavelengths by using the first and second scintillator layers 30₁ and 30₂ and process the electrical signals individually detected and obtained by the sensor unit 20. This can make the radiation detection apparatus 1 advantageous to the acquisition of high-resolution radiographic images and allows stable manufacture of the apparatus.

### Second Embodiment

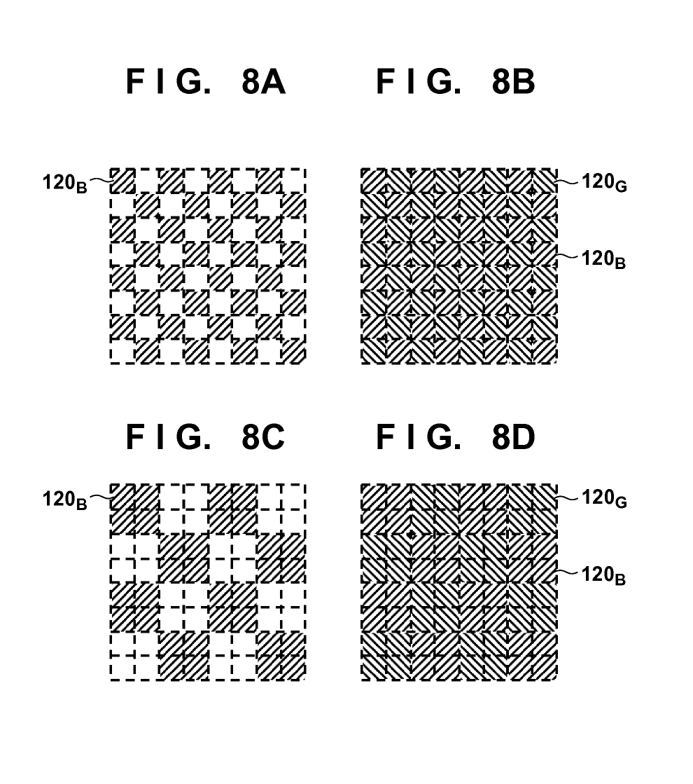

A radiation detection apparatus 2 according to the second embodiment will be described with reference to FIGS. 7A to 10. As exemplified by FIG. 7A, a sensor panel 10′ of the radiation detection apparatus 2 can include an insulating substrate 60 made of glass or the like, a TFT switch 70, an interlayer dielectric layer 80, a contact hole 90, and a sensor unit 20′. Amorphous silicon is used for the sensor unit 20′, on which a plurality of photoelectric converters 100 are two-dimensionally arranged. The TFT switch 70 can be disposed on the insulating substrate 60. The interlayer dielectric layer 80 is disposed to cover the insulating substrate 60 and the TFT switch 70. The contact hole 90 can be formed in the interlayer dielectric layer 80 in a region on the TFT switch 70. The photoelectric converter 100 can be connected to the contact hole 90. A passivation layer 110 can be provided so as to cover the interlayer dielectric layer 80 and the photoelectric converter 100. In addition, a planarizing layer 111 can be disposed on the passivation layer 110.

In this embodiment, the sensor panel 10′ of the radiation detection apparatus 2 can include a color filter layer 120. The color filter layer 120 can be disposed on the planarizing layer 111. As exemplified by FIG. 7B, this structure may not include the planarizing layer 111.

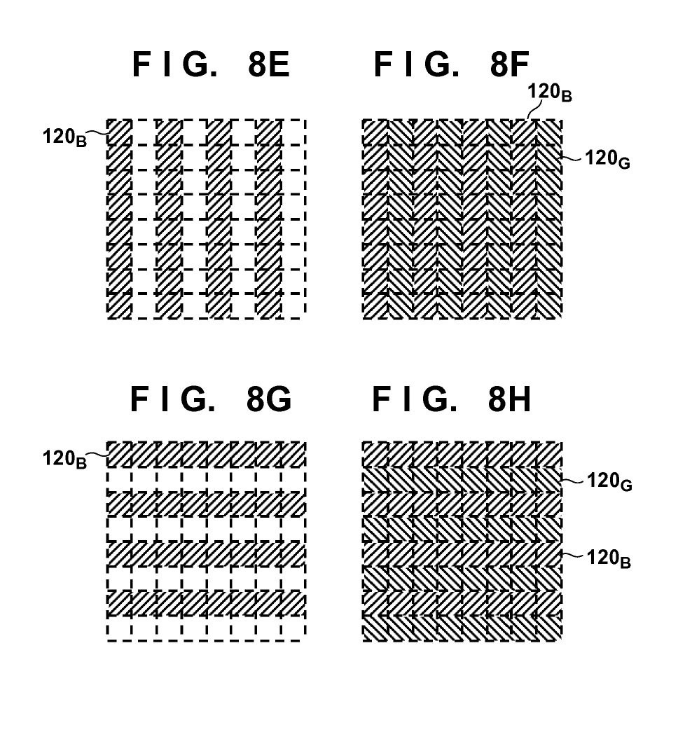

The color filter layer 120 can use a pattern like one of those exemplified by FIGS. 8A to 8H in accordance with the purpose and application. In this case, the color filter layer 120 uses, for example, blue filters 121_{B} and green filters 121_{G}. For example, FIG. 8A shows a pattern having the blue filters 121_{E} arranged every other pixel. For example, FIG. 8B shows a pattern having the blue filters 121_{B} and the green filters 121_{G} alternately arranged every other pixel. Alternatively, as exemplified by FIGS. 8C and 8D, the pattern of the color filter layer 120 may have filters arranged for every 2×2 pixels or can be changed, as needed. Alternatively, as exemplified by FIGS. 8E to 8H, the pattern of the color filter layer 120 may have filters arranged every other line vertically or horizontally or every other lines.

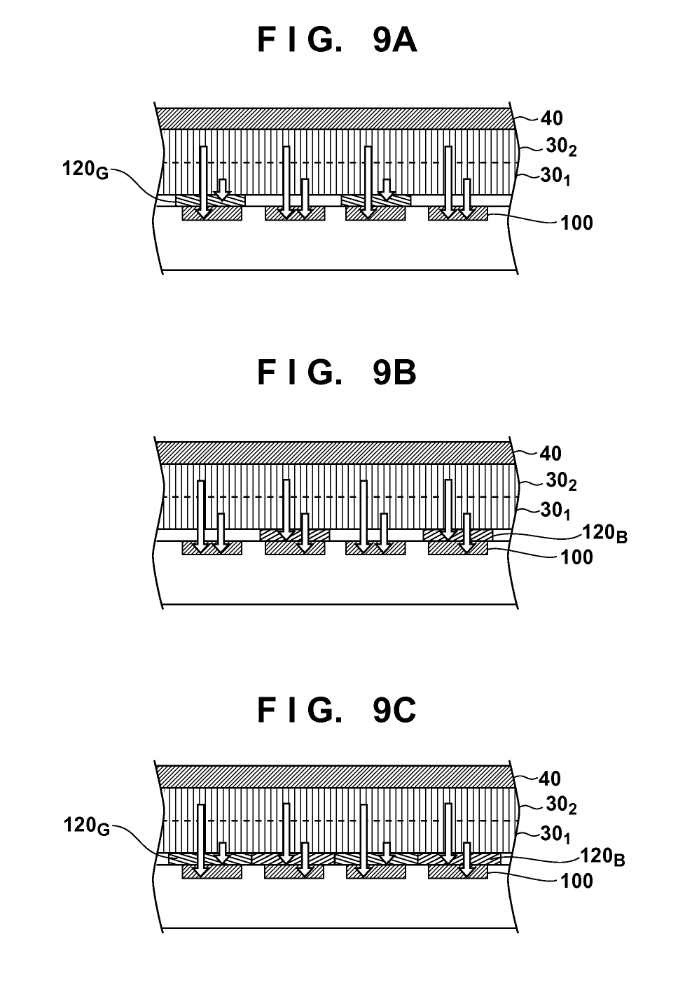

FIG. 9A shows a schematic sectional structure of the radiation detection apparatus 2 when the color filter layer 120 uses the green filters 121_{G} in the pattern exemplified by FIG. 8A. CsI:Na (a peak wavelength λ₁ of an emitted light beam is near 430 nm) is used for a first scintillator layer 30₁. CsI:Tl (a peak wavelength λ₂ of an emitted light beam is near 580 nm) is used for a second scintillator layer 30₂. In a pixel having the green filter 121_{G}, the light beam emitted by the first scintillator layer 30₁ can be absorbed by the green filter 121_{G}. For this reason, the photoelectric converter 100 can detect the light beam emitted by the second scintillator layer 30₂ of the first and second scintillator layers 30₁ and 30₂. On the other hand, in a pixel which does not have the green filter 121_{G}, the photoelectric converter 100 can detect the light beams emitted by the first and second scintillator layers 30₁ and 30₂.

FIG. 9B shows a schematic sectional structure of the radiation detection apparatus 2 when the color filter layer 120 uses the blue filters 121_{B} in the pattern exemplified by FIG. 8A. In a pixel having the blue filter 121_{B}, the light beam emitted by the second scintillator layer 30₂ can be absorbed by the blue filter 121_{B}. For this reason, the photoelectric converter 100 can detect the light beam emitted by the first scintillator layer 30₁ of the first and second scintillator layers 30₁ and 30₂. On the other hand, in a pixel which does not have the blue filter 121_{B}, the photoelectric converter 100 can detect the light beams emitted by the first and second scintillator layers 30₁ and 30₂.

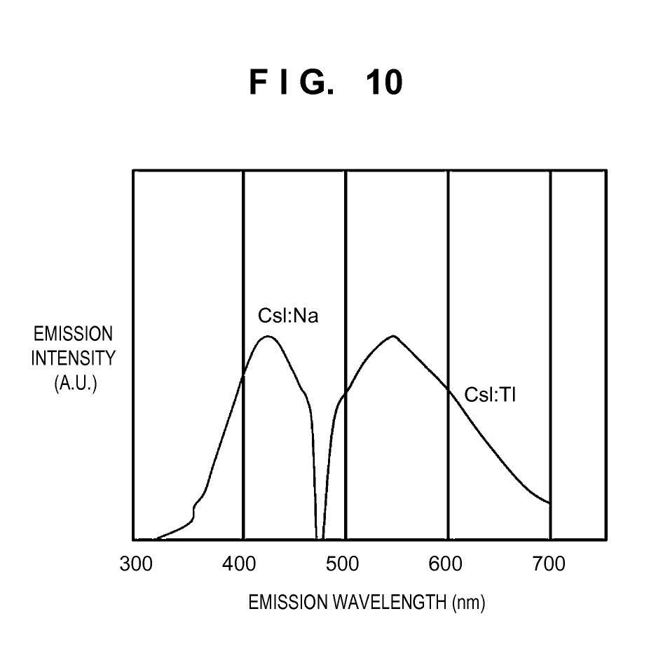

FIG. 9C shows a schematic sectional structure of the radiation detection apparatus 2 when the color filter layer 120 uses the blue filters 121_{E} and the green filters 121_{G} in the pattern exemplified by FIG. 8B. In a pixel having the blue filter 121_{B}, the light beam emitted by the second scintillator layer 30₂ can be absorbed by the blue filter 121_{B}. For this reason, the photoelectric converter 100 can detect the light beam emitted by the first scintillator layer 30₁ of the first and second scintillator layers 30₁ and 30₂. On the other hand, in a pixel which has the green filter 121_{G}, the green filter 121_{G} can absorb the light beam emitted by the first scintillator layer 30₁. For this reason, the photoelectric converter 100 can detect the light beam emitted by the second scintillator layer 30₂ of the first and second scintillator layers 30₁ and 30₂. When the radiation detection apparatus 2 uses the pattern of the color filter layer 120 shown in FIG. 8B, it is possible to avoid the wavelength distributions of light beams which can be detected by the sensor unit 20′ from overlapping each other, as shown in FIG. 10.

As described above, the radiation detection apparatus 2 includes the color filter layer 120 including at least one of the first and second light absorbing members (the green filter 121_{G} or the blue filter 121_{B} in this embodiment). The pattern of the color filter layer 120 may be determined in accordance with specifications so as to allow the photoelectric converters 100 to individually detect light beams having different wavelengths. In this manner, the radiation detection apparatus 2 can individually acquire pieces of information contained in a plurality of radiations. The radiation detection apparatus 2 is therefore advantageous to the acquisition of high-resolution radiographic images, and can be stably manufactured.

Although the two embodiments have been described above, the present invention are not limited to them. Obviously, the object, state, application, function, and other specifications of the present invention can be changed as needed, and the present invention can be implemented by other embodiments. For example, each embodiment described above acquires two radiographic images by using two scintillator layers. However, the design of each embodiment can be changed depending on the application, and may include three or more scintillator layers. In addition, for example, the second embodiment includes the sensor panel obtained by providing photoelectric converters using amorphous silicon on the insulating substrate. However, the embodiment may include a sensor panel having single-well, p-n junction photoelectric converters on a semiconductor substrate.

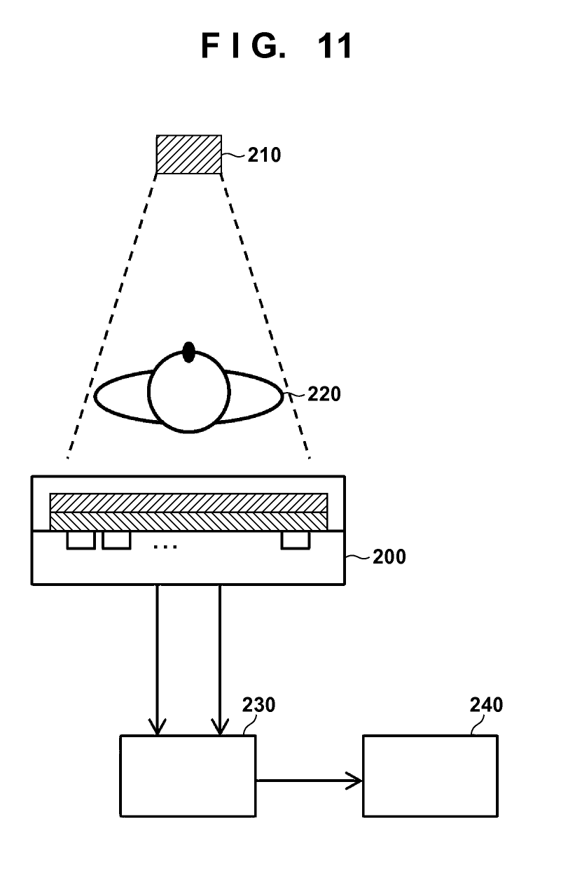

In addition, the radiation detection apparatuses 1 and 2 can be applied to a radiographic system, as shown in FIG. 11. For example, the radiation detection apparatus 1 can be attached to a case 200. Radiations (typified by X-rays) with different energy distributions emitted from a radiation source 210 are transmitted through an object 220. The radiation detection apparatus 1 can detect radiation containing information inside the body of the object 220. For example, a signal processing unit 230 performs predetermined subtraction processing by using the two radiographic images obtained by the above operation. With this operation, for example, an image depicting the soft tissue and bone tissue inside the body is acquired. A display unit 240 can display the resultant image.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-276140, filed Dec. 16, 2011, which is hereby incorporated by reference herein in its entirety.

What is claimed is:

1. A radiation detection apparatus comprising:
a sensor panel including sensor unit disposed on a plurality of photoelectric converters on a substrate;
a first scintillator layer disposed on said sensor panel; and
a second scintillator layer disposed on said first scintillator layer,
wherein said first scintillator layer and said second scintillator layer respectively emit light beams having different wavelengths, and
said sensor unit which includes a first photoelectric converter configured to detect the light beam emitted by said first scintillator layer, a first transistor configured to output a signal from said first scintillator layer, a second photoelectric converter configured to detect the light beam emitted by said second scintillator layer, and a second transistor configured to output a signal from said second scintillator layer, and individually convert the light beams having the different wavelengths into electrical signals.

2. The apparatus according to claim 1, wherein said first photoelectric converter and said second photoelectric converter are disposed at different depth positions from a surface of the substrate.

3. The apparatus according to claim 1, further comprising a color filter layer disposed between said sensor panel and said first scintillator layer,
wherein said first photoelectric converter and said second photoelectric converter are disposed along an upper surface of the substrate, and
said color filter layer includes at least one of a first light absorbing member disposed on the first photoelectric converter and a second light absorbing member disposed on the second photoelectric converter.

4. The apparatus according to claim 1, wherein said first scintillator layer contains CsI:Na, and
said second scintillator layer contains CsI:Tl.

5. A radiographic system comprising:
a radiation detection apparatus disclosed in claim 1;
a signal processing unit configured to process a signal from said radiation detection apparatus;
a display unit configured to display a signal from said signal processing unit; and
a radiation source configured to generate the radiation.
